(19) United States
(12) Patent Application Publication
(10) Pub. No.: US 2016/0260123 A1
(43) Pub. Date: Sep. 8, 2016

(54) SYSTEM AND METHOD FOR PROVIDING ADVERTISEMENT CONTENT IN A MEDIA CONTENT OR STREAMING ENVIRONMENT

(71) Applicant: SPOTIFY AB, Stockholm (SE)

(72) Inventors: Kinshuk Mishra, New York, NY (US); Michael Becker, New York, NY (US); Matt Brown, New York, NY (US); Noel Cody, New York, NY (US); Ranqi Zhu, New York, NY (US); Piyush Narang, New York, NY (US)

(21) Appl. No.: 15/063,283

(22) Filed: Mar. 7, 2016

Related U.S. Application Data
(60) Provisional application No. 62/129,686, filed on Mar. 6, 2015.

(51) Int. Cl. G06Q 30/02

(52) U.S. Cl. CPC G06Q 30/0244

(57) ABSTRACT

In accordance with an embodiment, described herein are a system and method for providing advertisement content in a media content or streaming environment. A media device, operating as a client device, can receive and play media content provided by a media server. An advertisement server can be used to determine advertisements or other promoted content to be delivered to the client in connection with the provided media content. An optimization service extends the advertisement server's in-built delivery optimization engine or functionality, for example by providing line-item tweaks to manipulate advertisement priority, effective price, or creative rotations; or by providing real-time bidding or pricing tweaks to allow content provider advertisements to compete dynamically with advertisements trafficked by the advertisement server. The advertisement delivery process can be adjusted for particular users, or to address behavioral attributes.

### CLAIM OF PRIORITY

This application claims the benefit of priority to U.S. Provisional Patent Application No. 62/129,686, titled “SYSTEM AND METHOD FOR OPTIMIZATION OF ADVERTISEMENT CONTENT IN A MEDIA CONTENT OR STREAMING ENVIRONMENT”, filed Mar. 6, 2015, which above application is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the invention are generally related to the providing of digital media content and advertising, and are particularly related to a system and method for providing advertisement or other promoted content in a media content or streaming environment.

### BACKGROUND

Today's consumers enjoy the ability to access a tremendous amount of media content, such as music and videos, at any location or time of day, using a wide variety of media devices. Media content providers, for example music streaming services such as Spotify, are ideally positioned to promote artists' works, and artist-related merchandise or information.

However, over time, regular media content and promotional or advertising messages may become increasingly similar and interrelated. Self-promotional or house advertisements may not be prioritized and delivered to the most-appropriate users, since these advertisements generally run at a lower priority. The actual selection of advertisements may not take into account, for example, a user's musical tastes. These are some examples of the challenges that embodiments described herein can be used to address.

### SUMMARY

In accordance with an embodiment, described herein are a system and method for providing advertisement content in a media content or streaming environment. A media device, operating as a client device, can receive and play media content provided by a media server. An advertisement server can be used to determine advertisements or other promoted content to be delivered to the client in connection with the provided media content. An optimization service extends the advertisement server's in-built delivery optimization engine or functionality, for example by providing line-item tweaks to manipulate advertisement priority, effective price, or creative rotations; or by providing real-time bidding or pricing tweaks to allow content provider advertisements to compete dynamically with advertisements trafficked by the advertisement server. The advertisement delivery process can be adjusted for particular users, or to address behavioral attributes.

### BRIEF DESCRIPTION OF THE FIGURES:

FIG. 1 illustrates an example of a system for providing media content, in accordance with an embodiment.

FIG. 2 further illustrates an example of a system for providing media content, in accordance with an embodiment.

FIG. 3 further illustrates an example of a system for providing media content, in accordance with an embodiment.

FIG. 4 illustrates a system for providing advertisement or other promoted content in a media content or streaming environment, in accordance with an embodiment.

FIG. 5 further illustrates a system for providing advertisement or other promoted content in a media content or streaming environment, in accordance with an embodiment.

FIG. 6 illustrates a process for providing advertisement or other promoted content in a media content or streaming environment, in accordance with an embodiment.

### DETAILED DESCRIPTION:

As described above, consumers enjoy the ability to access a tremendous amount of media content, such as music and videos, at any location or time of day, using a wide variety of media devices. Media content providers, for example music streaming services such as Spotify, are ideally positioned to promote artists' works, and artist-related merchandise or information. However, over time, regular media content and promotional or advertising messages may become increasingly similar and interrelated.

In accordance with an embodiment, described herein are a system and method for providing advertisement content in a media content or streaming environment. A media device, operating as a client device, can receive and play media content provided by a media server. An advertisement server can be used to determine advertisements or other promoted content to be delivered to the client in connection with the provided media content. An optimization service extends the advertisement server's in-built delivery optimization engine or functionality, for example by providing line-item tweaks to manipulate advertisement priority, effective price, or creative rotations; or by providing real-time bidding or pricing tweaks to allow content provider advertisements to compete dynamically with advertisements trafficked by the advertisement server. The advertisement delivery process can be adjusted for particular users, or to address behavioral attributes.

In accordance with an embodiment, the system comprises an optimization service, for use with an advertisement server, for use in determining an advertisement content to be provided to a media device, wherein the optimization service includes a network optimizer functionality, which receives line-item performance data associated with delivery of advertisements by the advertisement server, and updates line-items in the advertisement server with updated values for priority, price, or other delivery criteria, and a relevancy optimizer functionality, which evaluates delivery of line-items, after the network optimizer has updated them, and, based on such evaluation, ranks targeting features associated with users, so that a user will receive a relevant advertisement from a plurality of advertisements that are available to be delivered; and wherein, in association with providing a stream of one or more media content items to the media device, the providing of advertisement content to the media device is determined in response to a request for an advertisement to be played at the media device.

In accordance with an embodiment, the system further comprises a metadata ingester that collects line-item delivery data, performance data, and line-item metadata from the advertisement server, and provides it to a performance analyzer for use by the optimization service.

In accordance with an embodiment, the system further comprises the performance analyzer, which computes the performance on appropriate metrics, using data from the metadata ingester.

In accordance with an embodiment, the optimization service extends the advertisement server's in-built delivery optimization engine or functionality, by at least one of providing line-item tweaks to manipulate advertisement priority, effective price, or creative rotations; or providing real-time bidding or pricing tweaks to allow content provider advertisements to compete dynamically with advertisements trafficked by the advertisement server.

The above and additional embodiments are described in further detail below.

### Media Content Environment

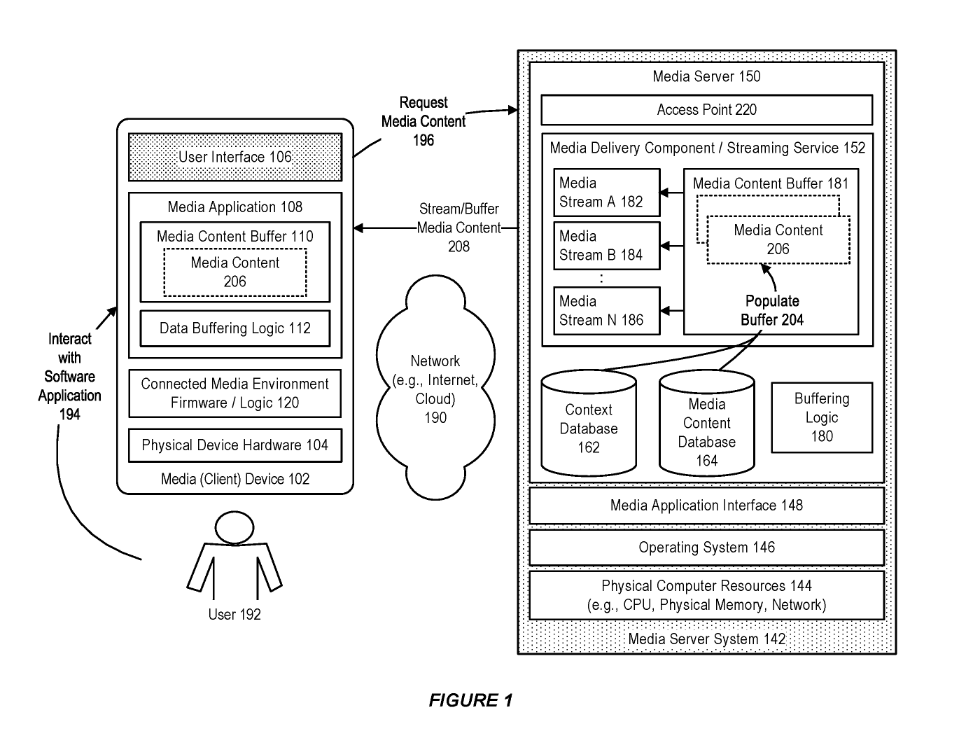

FIG. 1 illustrates an example of a system for providing media content, in accordance with an embodiment.

As illustrated in FIG. 1, in accordance with an embodiment, a media device 102, operating as a client device, can receive and play media content provided by a media server system 142 (media server), or by another system or peer device. In accordance with an embodiment, the client device can be, for example, a personal computer system, handheld entertainment device, tablet device, smartphone, television, audio speaker, in-car entertainment system, or other type of electronic or media device that is adapted or able to prepare a media content for presentation, control the presentation of media content, and/or play or otherwise present media content.

In accordance with an embodiment, each of the client device and the media server can include, respectively, one or more physical device or computer hardware resources 104, 144, such as one or more processors (CPU), physical memory, network components, or other types of hardware resources.

Although, for purposes of illustration, a single client device and media server are shown, in accordance with an embodiment a media server can support the simultaneous use of a plurality of client devices. Similarly, in accordance with an embodiment, a client device can access media content provided by a plurality of media servers, or switch between different media streams produced by one or more media servers.

In accordance with an embodiment, the client device can optionally include a display screen having a user interface 106, which is adapted to display media options, for example as an array of media tiles, thumbnails, or other format, and to determine a user interaction or input. Selecting a particular media option, for example a particular media tile or thumbnail, can be used as a command by a user and/or the client device, to the media server, to download advertisement, stream or otherwise access a corresponding particular media content item or stream of media content.

In accordance with an embodiment, the client device can also include a software media application 108, together with an in-memory client-side media content buffer 110, and a data buffering logic or software component 112, which can be used to control the playback of media content received from the media server, for playing either at a requesting client device (i.e., controlling device) or at a controlled client device (i.e., controlled device), in the manner of a remote control. A connected media environment firmware, logic or software component 120 enables the device to participate within a connected media environment.

In accordance with an embodiment, the data buffering logic, together with the media content buffer, enables a portion of media content items, or samples thereof, to be pre-buffered at a client device. For example, while media options are being prepared for display on a user interface, e.g., as media tiles or thumbnails, their related media content can be pre-buffered at the same time, and cached by one or more client devices in their media content buffers, for prompt and efficient playback when required.

In accordance with an embodiment, the media server system can include an operating system 146 or other processing environment which supports execution of a media server 150 that can be used, for example, to stream music, video, or other forms of media content to a client device, or to a controlled device.

In accordance with an embodiment, the media server can provide a subscription-based media streaming service, for which a client device or user can have an associated account and credentials, and which enable the user's client device to communicate with and receive content from the media server. A received media-access request from a client device can include information such as, for example, a network address, which identifies a destination client device to which the media server should stream or otherwise provide media content, in response to processing the media-access request.

For example, a user may own several client devices, such as a smartphone and an audio speaker, which can play media content received from a media server. In accordance with an embodiment, identifying information provided with a media-access request can include an identifier, such as an IP address, MAC address, or device name, which identifies that the media-access request is intended for use with a particular destination device. This allows a user, for example, to use their smartphone as a controlling client device, and their audio speaker as a controlled client device to which media content should be sent. The media server can then send the requested media and/or forward the media-access request to the audio speaker, even though the request originated at the user's smartphone.

In accordance with an embodiment, a media application interface 148 can receive requests from client devices, or from other systems, to retrieve media content from the media server. A context database 162 can store data associated with the presentation of media content by a client device, including, for example, a current position within a media stream that is being presented by the client device, or a playlist associated with the media stream, or one or more previously-indicated user playback preferences. The media server can transmit context information associated with a media stream to a client device that is presenting that stream, so that the context information can be used by the client device, and/or displayed to the user. The context database can be used to store a media device's current media state at the media server, and synchronize that state between devices, in a cloud-like manner. Alternatively, media state can be shared in a peer-to-peer manner, wherein each device is aware of its own current media state which is then synchronized with other devices as needed.

For example, in accordance with an embodiment, when the destination client device to which the media content is being streamed changes, from a controlling device to a controlled device, or from a first controlled device to a second controlled device, then the media server can transmit context information associated with an active media content to the newly-appointed destination device, for use by that device in playing the media content.

In accordance with an embodiment, a media content database 164 can include media content, for example music, songs, videos, movies, or other media content, together with metadata describing that media content. The metadata can be used to enable users and client devices to search within repositories of media content, to locate particular media content items.

In accordance with an embodiment, a buffering logic or software component 180 can be used to retrieve or otherwise access media content items, in response to requests from client devices or other systems, and to populate a server-side media content buffer 181, at a media delivery component/streaming service 152, with streams 182, 184, 186 of corresponding media content data, which can then be returned to the requesting device or to a controlled device.

In accordance with an embodiment, a plurality of client devices, media server systems, and/or controlled devices, can communicate with one another using a network, for example the Internet 190, a local area network, peer-to-peer connection, wireless or cellular network, or other form of network. For example, a user 192 can interact 194 with the user interface at a client device, and issue requests to access media content, for example the playing of a selected music or video item at their client device or at a controlled device, or the streaming of a media channel or video stream to their client device or to a controlled device.

In accordance with an embodiment, the user's selection of a particular media option can be communicated 196 to the media server, via the server's media application interface. The media server can populate its media content buffer at the server 204, with corresponding media content, 206 including one or more streams of media content data, and can then communicate 208 the selected media content to the user's client device, or to the controlled device as appropriate, where it can be buffered in a media content buffer for playing at the device.

In accordance with an embodiment, and as further described below, the system can include a server-side media gateway or access point 220, or other process or component, which operates as a load balancer in providing access to one or more servers, for use in processing requests at those servers. The system can enable communication between a client device and a server via an access point at the server, and optionally the use of one or more routers, to allow requests from the client device to be processed either at that server and/or at other servers.

For example, in a Spotify media content environment, most Spotify clients connect to various Spotify back-end processes via a Spotify “accesspoint”, which forwards client requests to other servers, such as sending one or more metadataproxy requests to one of several metadataproxy machines on behalf of the client or end user.

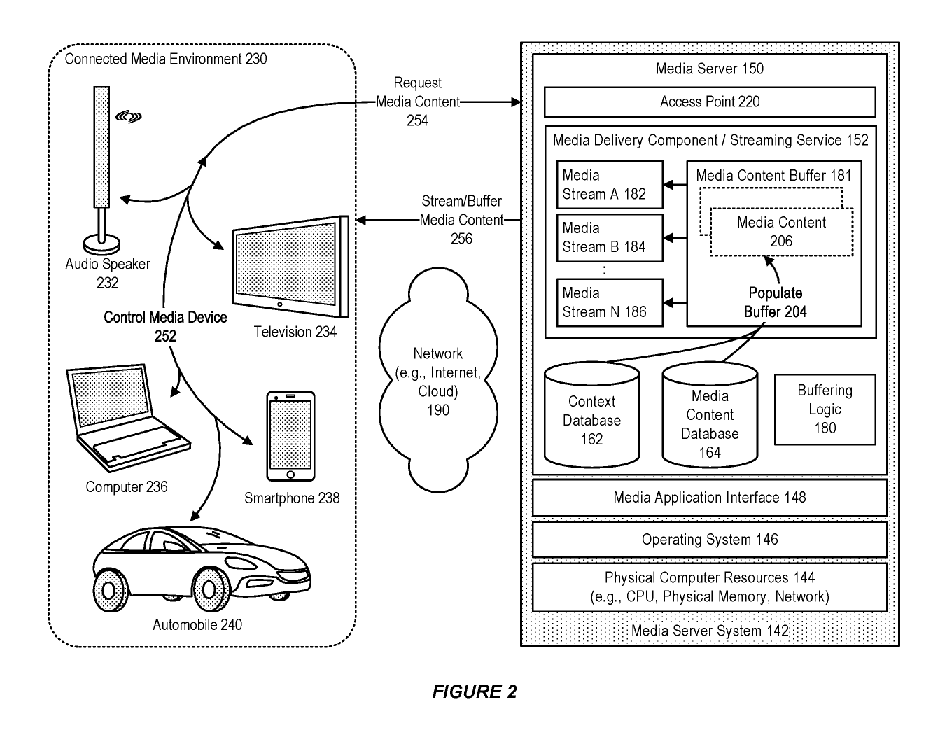

FIG. 2 further illustrates an example of a system for providing media content, in accordance with an embodiment.

As illustrated in FIG. 2, in accordance with an embodiment, a connected media environment 230, for example a Spotify Connect environment, enables communication between a client device and the server-side access point in a connected manner from the perspective of a user. Examples of the types of media device that can be provided within a connected media environment include audio speakers 232, televisions 234, computers 236, smartphones 238, and in-car entertainment systems 240, or other types of media device.

In accordance with an embodiment, a client device having an application user interface can act as a controlling client device, to control 252 the playback of media content at a controlled device. In accordance with an embodiment, a client device can itself act as a media gateway or access point, for use by other devices within the system for providing media content.

In accordance with an embodiment, a controlled device can also include a media application, which in the case of an audio speaker, television or similar device can be included within the device itself as a firmware logic or software component, or within, for example, a separate set-top box or similar after-market device.

As described above, in accordance with an embodiment, a user can interact with the user interface at a client device, and issue requests to access media content, for example the playing of a selected music or video item at their client device or at a controlled device, or the streaming of a media channel or video stream to their client device or to a controlled device.

For example, in accordance with an embodiment, a user can request that media content be buffered, streamed or received and played at a controlling client device such as a smartphone, and simultaneously buffered, streamed or received for playing at one or more controlled devices, such as an audio speaker. Similarly, for example, the user can issue a media-change request 254 to change a media channel, in response to which the media server can switch the media channel at the controlled device, and thereafter continue to stream or buffer media content 256 for the switched channel, at the controlled device.

As described above, in some instances, a portion of the media content can be pre-buffered at the controlled device, so that the switching to the channel at the controlled device operates in a seamless manner.

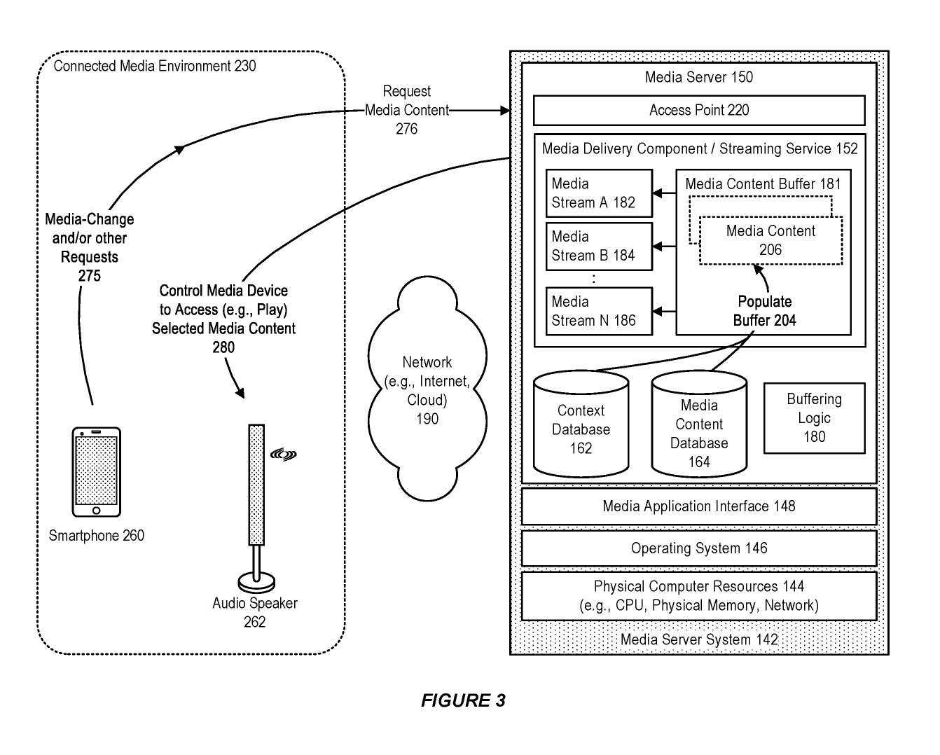

FIG. 3 further illustrates an example of a system for providing media content, in accordance with an embodiment.

As illustrated in FIG. 3, a user can utilize, for example, a smartphone 260 in combination with an audio speaker 262, to issue a media-change request 275 from the smartphone, for example, to change a media channel at the audio speaker. The request can be received by the media gateway or access point, and communicated to the local media server, or to other media servers, as a request for media content 276, which can then respond by controlling the destination device (in this example, the audio speaker) to access (e.g., play) the selected media content 280.

### Providing of Advertisement Content

In a media content or streaming environment, content providers can use an advertisement server, for example a DoubleClick for Publishers (DFP) ad server, to help manage their advertising campaigns and satisfy orders from advertising partners.

For example, a content provider can cause a code or tag to be placed into a media stream, and can associate advertising orders with line-items or advertising campaigns. An advertising campaign can include a variety of advertising creatives, for example banner advertisements. When the media stream is accessed by a user's media device, for example by playing a stream of songs, the code or tag can be used by the advertisement server to select or otherwise determine which advertising campaign should be used to deliver a particular advertisement, for example based on factors such as priority, time, duration, or cost-per-thousand-impressions (CPM).

Some advertisement servers, such as DFP, include an in-built delivery optimization engine or functionality that helps a content provider to deliver a high-value advertisement inventory, for example by looking at features in a particular advertisement request, and using a predictive model to estimate the click-through rate (CTR) of an advertisement, and compare that with a schedule or forecasted advertisement needs. After accounting for delivery goals for advertisements eligible to serve to an impression, the advertisement server can use the estimated CTR, in combination with historical data, as a basis for determining the best advertisement to serve.

For a media content provider to best utilize its network to promote content, it is advantageous if higher-value and/or more-relevant promotional or advertising messages are delivered on their platform, and that delivery is optimized to address desired metrics. For example, with a music streaming service, it is advantageous if music label advertisements can be delivered to particular users based on their musical tastes; or if improvements can be made to an advertisement server's default CPM/CTR-based optimization, to improve the likelihood that relevant and engaging advertisements are delivered to its users.

In accordance with an embodiment, the system can consider a variety of metrics, some examples of which are shown in Table 1, which can be adjusted for different goals across different advertisement formats or advertisement categories. Metrics can be weighted and ranked to compute a final effective score (e.g., an effective cost-per-thousand-impressions, eCPM) for each line-item. Based on a computed score for a line-item, the system can determine a relative priority and pricing for optimal delivery.

TABLE 1

| | Advertisement | Advertisement | |
|---|---|---|---|
| Metric | Category | Format | Goal |
| Click-Through Rate | All | All | Relevancy |
| Plays | Label | All | Promotion |
| Volume | All | Audio/Video | Relevancy |
| Completion Rate | All | Video | Relevancy/ |
| | | | Format Pricing |
| Conversion Rate | House | All | Growth |
| Average Revenue | Commercial | All | Revenue |
| per User Stream | | | |
| Advertisement | Commercial | All | Revenue |
| Spend | | | |
| Frequency | All | Audio | Revenue/ |
| | | | Utilization |
| Registrations | House | All | Growth |
| Mid-Roll Offer | Commercial | Video | Revenue |
| Conversion | | | |
| Pre-Roll Offer | Commercial | Video | Revenue |
| Conversion | | | |
| End Card CTR | Commercial | Video | Revenue |

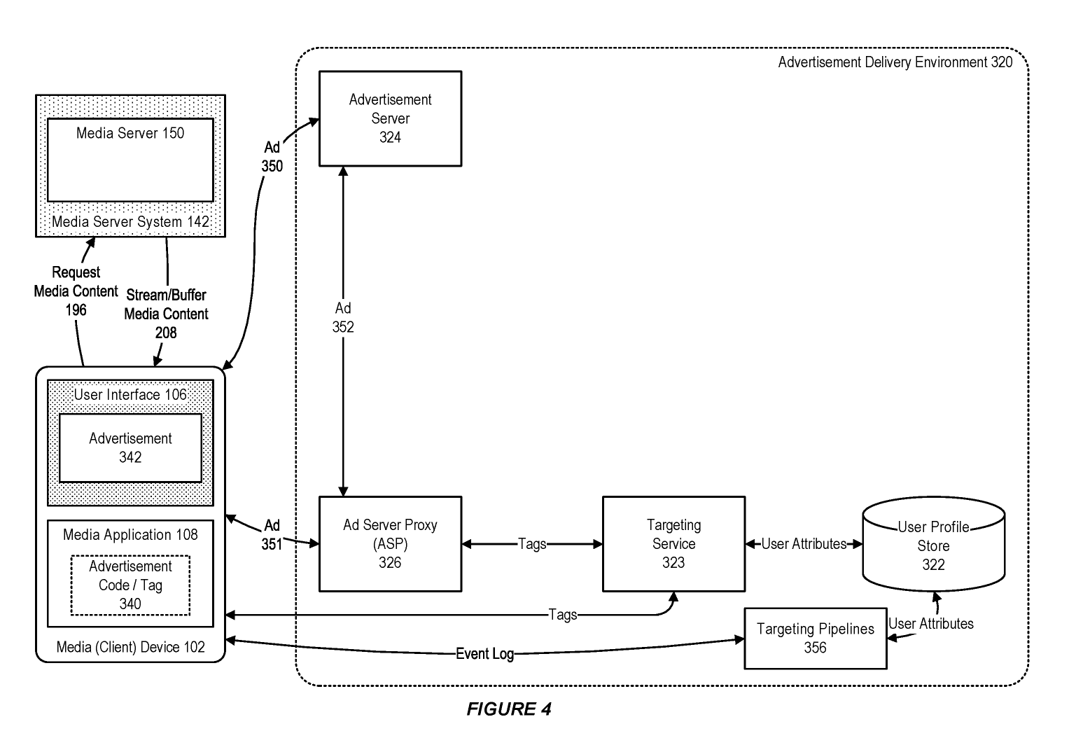

FIG. 4 illustrates a system for providing advertisement or other promoted content in a media content or streaming environment, in accordance with an embodiment.

As illustrated in FIG. 4, in accordance with an embodiment, a user can interact with a media device or client (e.g., a Spotify client), and issue requests to access media content at a media server (e.g., a Spotify server), for example, to stream music, video, or other forms of media content to the media device. In response, the media server can populate a media content buffer with corresponding items of media or sponsor-directed content, for example as one or more streams of media content and/or advertisement or other sponsor-directed content, and communicate the selected media content to the user's media device.

In accordance with an embodiment, during user interaction events that result in an advertisement being selected for playing, information can be communicated to an advertisement delivery environment 320, which analyzes user contextual signals such as, for example the user's current environment, or the time of day; and behavioral habits such as, for example, the user's preference for certain kinds of music at certain times of day.

In accordance with an embodiment, a user profile store 322 can be used to store user-specific information, which can be looked up in real-time, and provided to a targeting service 323. When a client media device makes a call either directly to an advertisement server 324, or to an ad server proxy (ASP) 326, the targeting service can be called, generally with a client or user id, and other attributes by which the system can target a particular advertisement to that user or device. A response can then be provided to the client media device in the form of an advertisement code or tag 340, which enables the client media device to make the call to the advertisement server to return the advertisement 342, either by directly calling the advertisement server (350), or the ad server proxy (351) in communication with the advertisement server (352).

In accordance with an embodiment, an advertisement delivery flow can include targeting pipelines 356, that can be adapted to consider user attributes, and real-time and batch targets, which enable the system to provide targeting that improves both user engagement and advertisement spend. Examples include determining that a user has reached a diminishing return for a particular advertisement and not allowing that advertisement to serve; optimizing users who are likely to click, for example, on the end card of a video advertisement; identifying users likely to use a particular service of the content provider and bubble up house advertisements to the top of the advertisement stack; and/or identifying a user as a fan/follower of a particular, e.g., artist/playlist, and driving higher consumption of that play object.

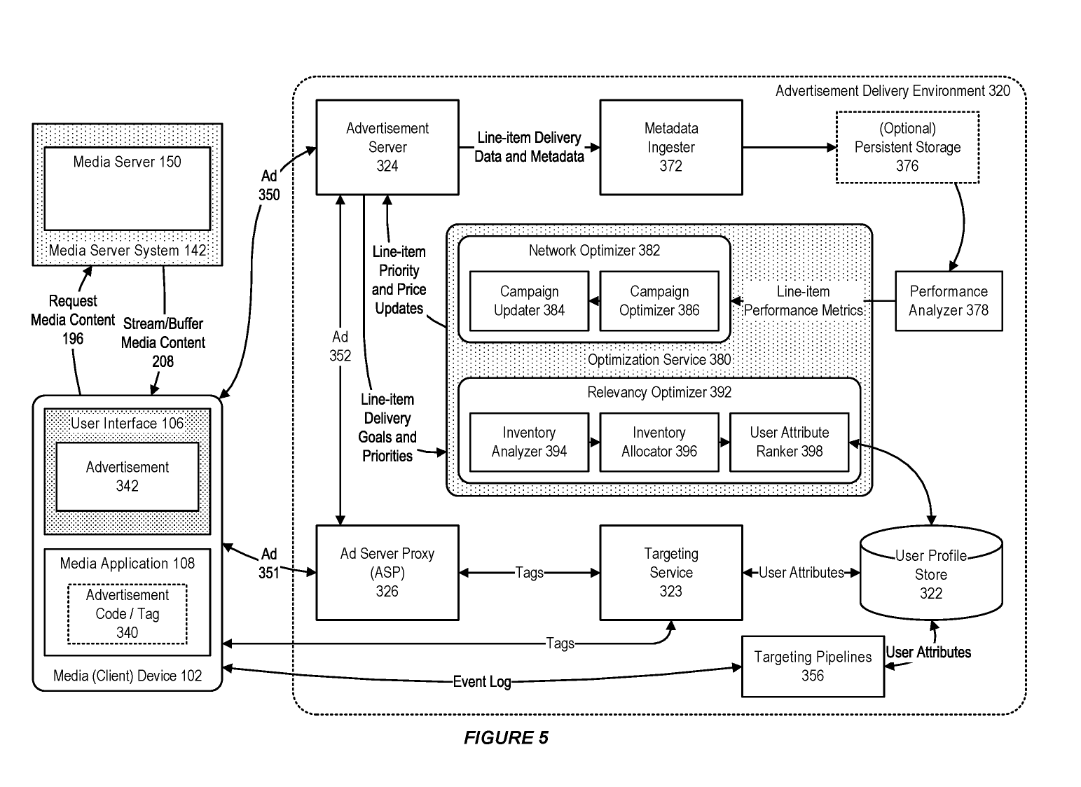

FIG. 5 further illustrates a system for providing advertisement or other promoted content in a media content or streaming environment, in accordance with an embodiment.

In accordance with an embodiment, during selection of one or more advertisements to stream, the choice of which relevant line-item to serve to a user can be determined by a line-item's priority (e.g., based on a goal type), pacing (if an absolute impression goal), effective price (if an unlimited impression goal), and/or a creative rotation rule.

In accordance with an embodiment, the system can extend an advertisement server (e.g., DFP's) in-built optimization engine or functionality, for example by providing programmatic line-item tweaks on the advertisement server, to manipulate advertisement priority, and/or effective price and creative rotation rules; and/or real-time bidding (RTB) pricing tweaks using, e.g., Advertisement Exchange, to create a private exchange and to allow content provider advertisements on the exchange to compete dynamically with equal or lower priority ad-server-trafficked advertisements.

Whereas previously, changes to the advertising delivery metrics may have required modifying the logic in the advertisement server itself, in accordance with an embodiment the system allows for monitoring the performance of advertising campaigns outside of, or external to, the advertisement server, and then reporting into the advertisement server to make changes. Since it is difficult to measure the performance of an advertising campaign without direct access to the advertisement server, the system can evaluate the information received from the advertisement server, and use that information to determine metrics. An advantage of this approach is that it is not as strictly focused on CPM and CTR metric, but can also consider downstream metrics, which may be more useful in improving user engagement and advertisement revenue.

In accordance with an embodiment, the user profile store can include user profile information and their interactions. Although line-items clicked are generally not stored in the user profile store, in some instances this information may be logged in the user profile. Advertising campaign logs from advertisement servers generally can be imported into the environment as user-specific information. Instead of the actual user id, an anonymous id can be used, which is then internally mapped to the actual user id.

In accordance with an embodiment, the system can compute performance of all the advertisements, for example on a daily basis in a batch pipeline, assign a score to each line-item based on its performance and delivery goals, and then run periodic (e.g., nightly) jobs to update the priorities and eCPM values of the line-items in the advertisement server.

As illustrated in FIG. 5, in accordance with an embodiment, a metadata ingester 372 collects line-item delivery data (e.g., completion rate, impressions delivered), performance data (e.g., CTR), and line-item metadata (e.g., delivery goals, CPM, current priority) from an advertisement server (e.g., DFP), in connection with line-item advertising campaigns at that advertisement server. Examples of additional types of information that can be received include pricing targeting features, advertisement formats, creatives corresponding to line-items, or caps on the number of times an advertisement can be delivered.

In accordance with an embodiment, the ingested information is kept in memory, but optionally can be persisted e.g. to a Hadoop or other type of persistent storage or file system 376, for storage and subsequent processing of the information.

In accordance with an embodiment, a performance analyzer 378, for example a Crunch pipeline or other type of processing pipeline, can compute performance based on appropriate metrics, using the advertisement server data received from the metadata ingester, content provider data, and/or other advertisement event logs. The resultant metrics can be used to update the advertising campaigns, for example to adjust pricing based on the performance of an advertising campaign, as measured by click-through or engagements, e.g., to relax the line-item price. Decisions can be made on priority, relevance or other factors.

In accordance with an embodiment, an optimization service 380 can include a network optimizer functionality 382 (for example, a DFP network optimization module), which receives line-item performance data from the performance analyzer, and updates line-items in the advertisement server with updated values for priority, price, or other delivery criteria.

In accordance with an embodiment, the network optimizer can further include a campaign optimizer 384, which processes the performance data of line-items, evaluates daily goals, and assigns a score to each line-item to determine its priority, pricing; and a campaign updater 386, which takes the output of the advertising campaign optimizer and updates those values in the advertisement server.

In accordance with an embodiment, the optimization service can also include a relevancy optimizer functionality 392, which determines expected delivery of line-items, after the network optimizer has updated them (for example, by querying the advertisement server daily to determine goals and priorities), and, based on such evaluation, ranks different targeting features associated with users, so that each user receives a relevant advertisement from a plurality of advertisements that are available to be delivered that day.

In accordance with an embodiment, the relevancy optimizer can further include an inventory analyzer 394, which queries the advertisement server to obtain the expected delivery and priority of the line-items; an inventory allocator 396, which uses a priority-ranked list of line-items and their delivery goals and targeting parameters to determine which targeting parameters need to be emitted the most and how many times, and also queries the user profile store to determine all the possible targeting parameter available for users that day and allocates inventory to different user types globally; and a user attribute ranker 398, which, based on the global inventory allocation to different user types, identifies which user attributes should be bumped up to meet the inventory goals, for example by ranking all the user specific attributes, and stores the ranked attributes in the user profile store.

In accordance with an embodiment, the targeting service can read the attribute ranking data and the attributes for each user from an advertisement profile during an advertisement call, and, based on the rank, emits the top key value pairs for each user during the day. The system can additionally or alternatively compute performance of all the advertisements trafficked via the exchange in real-time, assigning a score to each line-item based on its performance and delivery goals, and feeding that to the advertisement server's optimization engine or functionality which can then update the effective value of all the line-items. Based on the effective value of all the line-items, top line-items can be chosen to bid for the next available advertisement slot, and a pricing engine can determine the bid price.

In accordance with other embodiments, the system can include other methods, for example, manipulations of custom targeting and priority levels to update an advertisement in question with a different set of priorities and targeting, to ensure that it is the only advertisement available for a particular impression.

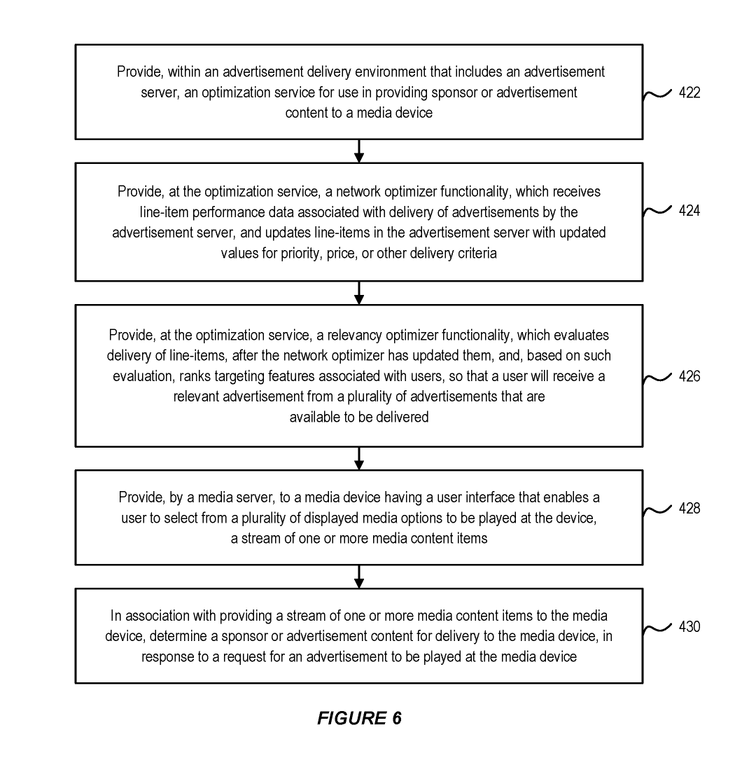

FIG. 6 illustrates a process for providing advertisement or other promoted content in a media content or streaming environment, in accordance with an embodiment.

As illustrated in FIG. 6, in accordance with an embodiment, at step 422, an optimization service is provided within an advertisement delivery environment that includes an advertisement server, for use in providing advertisement content to a media device.

At step 424, a network optimizer functionality is provided at the optimization service, which receives line-item performance data associated with delivery of advertisements by the advertisement server, and updates line-items in the advertisement server with updated values for priority, price, or other delivery criteria.

At step 426, a relevancy optimizer functionality is provided at the optimization service, which evaluates delivery of line-items, after the network optimizer has updated them, and, based on such evaluation, ranks targeting features associated with users, so that a user will receive a relevant advertisement from a plurality of advertisements that are available to be delivered.

At step 428, a stream of one or more media content items is provided to a media device having a user interface that enables a user to select from a plurality of displayed media options to be played at the device.

At step 430, in association with providing a stream of one or more media content items to the media device, an advertisement or other promoted content is determined for delivery to the media device, in response to a request for an advertisement to be played at the media device.

Embodiments of the present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a non-transitory storage medium or computer readable medium (media) having instructions stored thereon/in which can be used to program a computer to perform any of the processes of the present invention. Examples of the storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated.

What is claimed is:

1. A system for providing advertisement or other promoted content in a media content or streaming environment, comprising:
a computer including a processor;
an optimization service, for use with an advertisement server, for use in determining an advertisement content to be provided to a media device, wherein the optimization service includes
a network optimizer functionality, which receives line-item performance data associated with delivery of advertisements by the advertisement server, and updates line-items in the advertisement server with updated values for priority, price, or other delivery criteria, and
a relevancy optimizer functionality, which evaluates delivery of line-items, after the network optimizer has updated them, and, based on such evaluation, ranks targeting features associated with users, so that a user will receive a relevant advertisement from a plurality of advertisements that are available to be delivered; and
wherein, in association with providing a stream of one or more media content items to the media device, the providing of advertisement content to the media device is determined in response to a request for an advertisement to be played at the media device.

2. The system of claim 1, wherein the system further comprises a metadata ingester that collects line-item delivery data, performance data, and line-item metadata from the advertisement server, and provides it to a performance analyzer for use by the optimization service.

3. The system of claim 2, wherein the system further comprises the performance analyzer, which computes the performance on appropriate metrics, using data from the metadata ingester.

4. The system of claim 1, wherein the optimization service extends the advertisement server's in-built delivery optimization engine or functionality, by at least one of:
providing line-item tweaks to manipulate advertisement priority, effective price, or creative rotations; or
providing real-time bidding or pricing tweaks to allow content provider advertisements to compete dynamically with advertisements trafficked by the advertisement server.

5. A method of optimizing advertisement content in a media content or streaming environment, comprising:
providing, at a computer, an optimization service, for use with an advertisement server, for use in determining an advertisement content to be provided to a media device, wherein the optimization service includes
a network optimizer functionality, which receives line-item performance data associated with delivery of advertisements by the advertisement server, and updates line-items in the advertisement server with updated values for priority, price, or other delivery criteria, and
a relevancy optimizer functionality, which evaluates delivery of line-items, after the network optimizer has updated them, and, based on such evaluation, ranks targeting features associated with users, so that a user will receive a relevant advertisement from a plurality of advertisements that are available to be delivered; and
wherein, in association with providing a stream of one or more media content items to the media device, the providing of advertisement content to the media device is determined in response to a request for an advertisement to be played at the media device.

6. The method of claim 5, further comprising providing a metadata ingester that collects line-item delivery data, performance data, and line-item metadata from the advertisement server, and provides it to a performance analyzer for use by the optimization service.

7. The method of claim 6, further comprising providing the performance analyzer, which computes the performance on appropriate metrics, using data from the metadata ingester.

8. The method of claim 5, wherein the optimization service extends the advertisement server's in-built delivery optimization engine or functionality, by at least one of
providing line-item tweaks to manipulate advertisement priority, effective price, or creative rotations; or
providing real-time bidding or pricing tweaks to allow content provider advertisements to compete dynamically with advertisements trafficked by the advertisement server.

9. A non-transitory computer readable storage medium, including instructions stored thereon which when read and executed by one or more computers cause the one or more computers to perform the steps comprising:
providing, at a computer, an optimization service, for use with an advertisement server, for use in determining an advertisement content to be provided to a media device, wherein the optimization service includes
a network optimizer functionality, which receives line-item performance data associated with delivery of advertisements by the advertisement server, and updates line-items in the advertisement server with updated values for priority, price, or other delivery criteria, and
a relevancy optimizer functionality, which evaluates delivery of line-items, after the network optimizer has updated them, and, based on such evaluation, ranks targeting features associated with users, so that a user will receive a relevant advertisement from a plurality of advertisements that are available to be delivered; and
wherein, in association with providing a stream of one or more media content items to the media device, the providing of advertisement content to the media device is determined in response to a request for an advertisement to be played at the media device.

10. The non-transitory computer readable storage medium of claim 9, further comprising providing a metadata ingester that collects line-item delivery data, performance data, and line-item metadata from the advertisement server, and provides it to a performance analyzer for use by the optimization service.

11. The non-transitory computer readable storage medium of claim 10, further comprising providing the performance analyzer, which computes the performance on appropriate metrics, using data from the metadata ingester.

12. The non-transitory computer readable storage medium of claim 9, wherein the optimization service extends the advertisement server's in-built delivery optimization engine or functionality, by at least one of:
providing line-item tweaks to manipulate advertisement priority, effective price, or creative rotations; or
providing real-time bidding or pricing tweaks to allow content provider advertisements to compete dynamically with advertisements trafficked by the advertisement server.
